(19) United States
(12) Patent Application Publication
(10) Pub. No.: US 2010/0062290 A1
(43) Pub. Date: Mar. 11, 2010

(54) METHOD FOR TESTING THE IMPERMEABILITY OF A FUEL CELL STACK

(75) Inventors: Andreas Reinert, Dresden (DE); Björn Erik Mai, Dresden (DE); Jeremy Lawrence, Dresden (DE); Stefan Megel, Dresden (DE)

Correspondence Address: FITCH, EVEN, TABIN & FLANNERY, P. O. BOX 18415, WASHINGTON, DC, 20036, US

(73) Assignee: Staxera GmbH, Dresden (DE)

(21) Appl. No.: 12/531,619

(22) PCT Filed: Mar. 31, 2008
(86) PCT No.: PCT/DE08/00547

§ 371 Date: Nov. 17, 2009

(30) Foreign Application Priority Data
Apr. 4, 2007 (DE) 10 2007 016 307.1

(51) Int. Cl. H01M 8/04

(52) U.S. Cl. 429/13

(57) ABSTRACT

The invention relates to a method for testing the leak-tightness of a fuel cell stack comprising the steps of operating the fuel cell stack using defined gas supply rates, a defined modification of at least one gas supply rate, detecting at least one cell or cell group voltage and analysing the variation in time of the at least one cell or cell group voltage.

The invention relates to a method for testing the leak-tightness of a fuel cell stack.

To operate fuel cells it is necessary to supply operating gases, i.e. particularly air containing oxygen as an oxidant and a reformate rich in hydrogen. In this connection, the various gas ducts are required to be leak-tight to avoid an undesirable leakage of the gases from the fuel cells stack or an undesirable transfer of the gases between the anode space and cathode space of the fuel cells. To be able to ensure the leak-tightness of fuel cell stacks leak-tightness tests are required. They are carried out particularly during the production and release stage as well as during the operation of the systems. Leak-tightness tests are also useful in connection with endurance tests of the fuel cell stack. In case of an insufficient leak-tightness of a fuel cell stack fires may occur which may lead to a more rapid corrosion and finally to the destruction of the fuel cell stack. Furthermore, there is the risk of exceeding threshold values relating to the gases involved, for example carbon monoxide contained in the reformate which is highly hazardous to health even in small concentrations. The testing of the leak-tightness of fuel cells stacks using pressure and volume flow measurements is known. Further, electro-chemical testing methods are known which are based on the detection of the idle voltage or the Nernst voltage under a continuous supply of the reacting gases to the fuel cell stack.

In the known methods for testing the leak-tightness various problems occur. They particularly relate to the sensitivity of the methods since minor untightnesses are to be detected as well. Therefore the sensitivity is not satisfactory even in case of the known electro-chemical methods. This particularly applies if not each individual cell is monitored in case of large cell stacks. If, however, each individual cell is to be monitored, the problem is that an enormous operating expense is required since each individual cell has to be connected via platinum contacts. In addition, preferably pure hydrogen is used for the electro-chemical leak-tightness test. This is disadvantageous in that hot fires are generated by the oxidation of the pure hydrogen which may damage the fuel cells stack. In so far the leak-tightness test may even cause or intensify leakages. The option of a subsequent sealing in case of a detected untightness may thus be lost.

The invention is based on the object to provide a method for a sensitive testing of the leak-tightness of a fuel cell stack at low cost.

Said object is solved by the features of the independent claim.

Advantageous embodiments of the invention are described in the dependent claims.

The invention consists in a method for testing the leak-tightness of a fuel cell stack comprising the steps of:
operating the fuel cell stack using defined gas supply rates,
a defined modification of at least one gas supply rate,
detecting at least one cell or cell group voltage, and
analysing the variation in time of the at least one cell or cell group voltage.

Within the framework of the present method the fuel cell stack is preferably flooded with operating gases at the operating temperature for a certain period of time. For this purpose particularly air for the cathode space and formation gas, i.e. 95% nitrogen together with 5% hydrogen, qualify. By changing at least one gas supply rate the cell or cell group voltages also change. If the fuel cells stack is tight the voltage change takes place in a reproducible or predictable manner. Monitoring the cell or cell group voltages may thus yield information as to whether the cell stack is actually tight or which cells or cell groups are leaky.

It may, in particular, be contemplated that the variation in time of the voltage itself is taken into consideration in the analysis of the variation in time of the voltage.

It may also be contemplated that the first derivative of the voltage with respect to time is taken into consideration in the analysis of the variation in time of the voltage.

According to another embodiment of the method according to the invention it is contemplated that the second derivative of the voltage with respect to time is taken into consideration in the analysis of the variation in time of the voltage. On principal higher order derivatives may also be taken into consideration in the analysis of the variation in time of the voltage, the analysis of the variation in time of the voltage itself, of the first derivative of the voltage and possibly also of the second derivative of the voltage, however, being sufficient in general.

Conveniently it may be contemplated that the analysis of the variation in time of the voltage comprises a comparison of the variation in time of the voltages of different cells or cell groups. If the voltage of certain cells or cell groups deviates from that of the other cells or cell groups in a particularly strong manner this indicates a leakage. The standard deviation of the cell voltages or cell group voltages with time is therefore a useful criterion in view of the leak-tightness test.

It may further be contemplated that the analysis of the variation in time of the voltage comprises a comparison of variation in time of voltages with variation in time of voltages to be expected in case of a sufficient leak-tightness. In known types of fuel cells stacks a specific variation in time of the voltage profile is to be expected after the defined change of the gas supply rate. The comparison of the cell voltages or cell group voltages with such empiric values therefore offers a useful option for the detection of distinctive features and thus for testing the leak-tightness of the cells.

The invention is advantageously further developed by the detection of at least one cell or cell group voltage prior to the defined change of the gas supply rate and by the induction of the defined change of the at least one gas supply rate after the at least one cell or cell group voltage is substantially constant. This may, for example, be the case after the fuel cell stack has been supplied with gas for ten minutes at the operating temperature, the usual variations of the cell voltages being taken into consideration in the judgement of whether it can be regarded as substantially constant.

Preferably the defined change of the at least one gas supply rate is induced by a complete cut-off of at least one gas supply. In this way the largest possible change is obtained with respect to the observed gas supply so that a great influence on the variation in time of the voltage is to be expected. Therefore, the method is particularly sensitive in this way.

However, it is also feasible that the defined change of the at least one gas supply rate is induced by changing the pressure of the at least one gas supply while maintaining the gas supply.

In another particularly preferred embodiment of the method according to the invention it is contemplated that the supply rates of the gases supplied to the anode spaces as well as to the cathode spaces are changed in a defined manner. In case of a complete cut-off of both gas supplies the cell voltages will drop continuously until a voltage value of approximately 680 mV is reached in case of the utilisation of nickel anodes, said value of 680 mV being the oxidation potential of Ni/NiO. Anyway, the greatest influence on the variation in time of the voltage is to be expected in case of a complete cut-off of both gas supplies.

The invention will now be explained by way of example quoting particularly preferred embodiments with reference to the accompanying drawings in which:

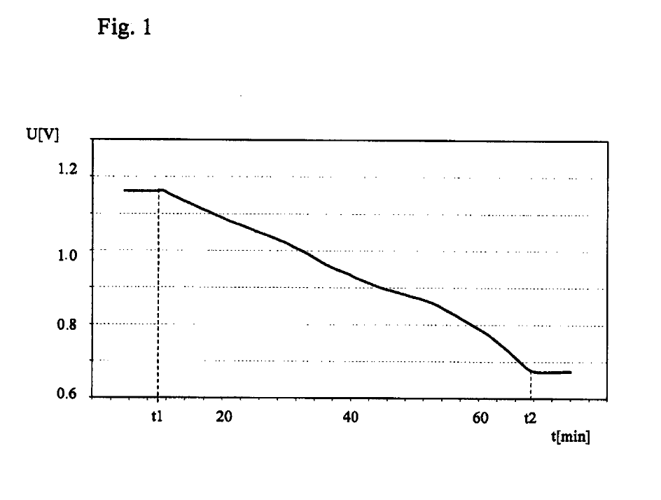

FIG. 1 shows the variation in time of a typical cell voltage curve;

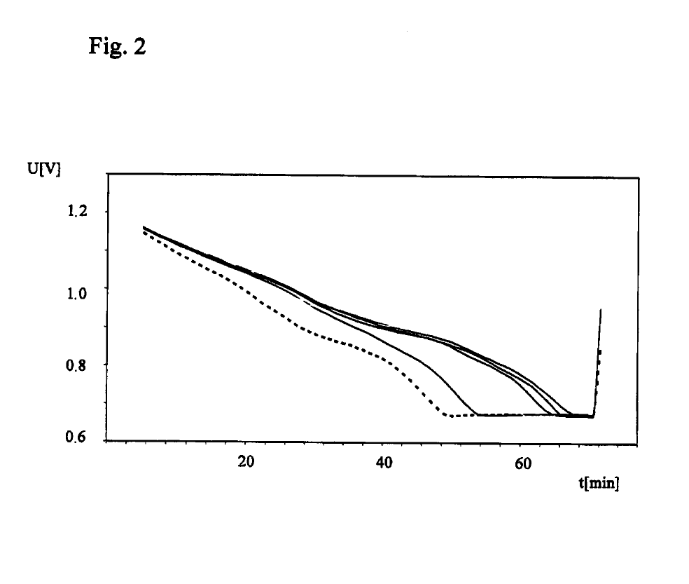

FIG. 2 shows various cell voltage curves with respect to time in case of a complete cut-off of the gas supplies;

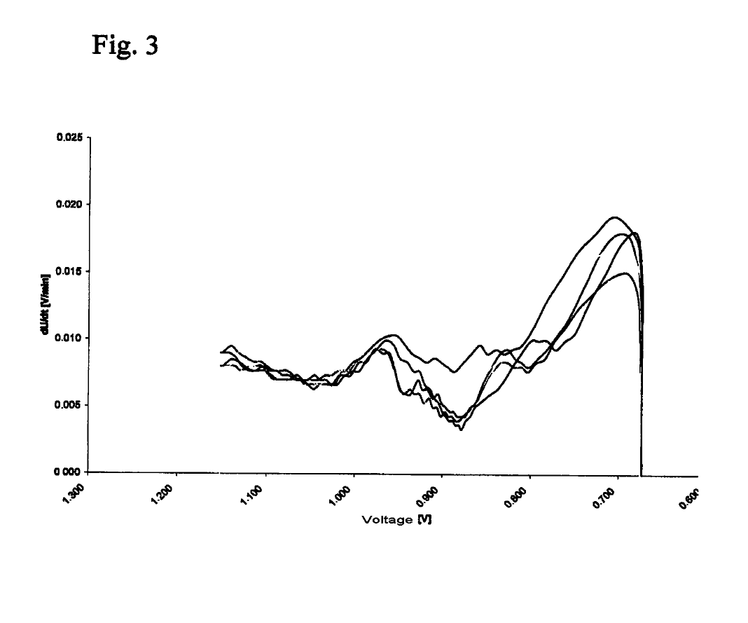

FIG. 3 shows various curves of the first derivative of cell voltages with respect to time plotted against the voltage in case of a complete cut-off of the gas supplies;

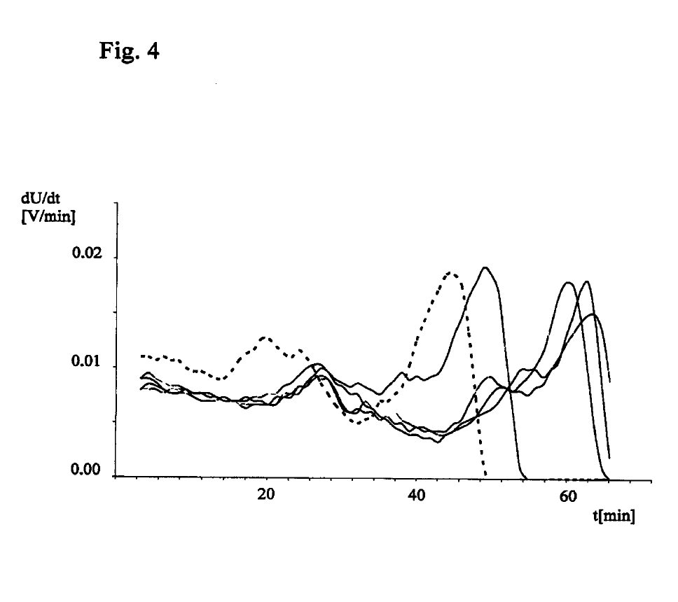

FIG. 4 shows various curves of the first derivative of cell voltages with respect to time plotted against time in case of a complete cut-off of the gas supplies;

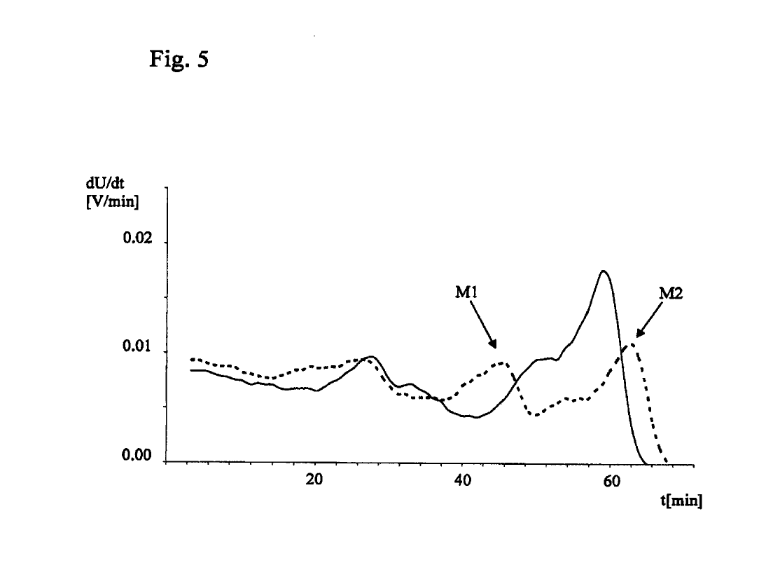

FIG. 5 shows various curves of the first derivative of cell voltages with respect to time plotted against time in case of a complete cut-off of the gas supplies; and

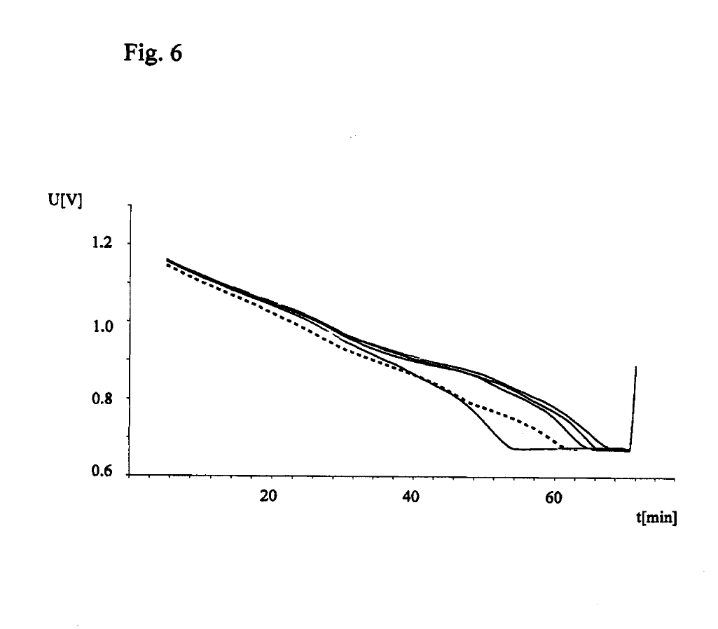

FIG. 6 shows various cell voltage curves or cell group voltage curves with respect to time in case of a complete cut-off of the gas supplies.

FIG. 1 shows the variation in time of a typical cell voltage curve. The cell voltage curve is constant in the beginning, the operating gases being supplied with a constant supply rate in this stage. At the time t1 the supply of both operating gases is cut off so that the cell voltage drops. Said drop stops at approximately 680 mV, i.e. in case of a fuel cell stack having nickel anodes the oxidation potential of Ni/NiO, at a time t2. The drop in voltage may typically take approximately one hour. Thereafter an oxidation of the nickel anodes takes place.

FIG. 2 shows the variation in time of various cell voltage curves in case of a complete cut-off of the gas supplies. In these cell voltage curves particularly the curve indicated by a dotted line attracts attention. The voltage reaches the final constant value of approximately 680 mV significantly earlier than the other curves so that it is quite probable that the cell associated to this voltage curve is leaky.

FIG. 3 shows various curves of the first derivative of cell voltages with respect to time plotted against the voltage in case of a complete cut-off of the gas supplies. The first derivative of the cell voltage with respect to time represents the speed of the voltage drop. This drop occurs in the form of a characteristic curve, whereas two areas having distinctive maxima being characteristic. The maximum shortly before reaching the final constant voltage value is particularly prominent.

FIG. 4 shows various curves of the first derivative of cell voltages with respect to time plotted against time in case of a complete cut-off of the gas supplies. It can be seen that some cells reach the final maximum earlier than other cells which indicates leakages in these cells.

FIG. 5 shows various curves of the first derivative of cell voltages with respect to time plotted against time in case of a complete cut-off of the gas supplies. Each of these two curves is allocated to a group of three cells. The solid line has a course which doesn't show any specific particularities. In particular there is a final maximum before reaching the constant cell voltage value. The broken line, in contrast, has two maxima (M1, M2), i.e. at least one cell of the allocated group of three reaches the oxidation potential of Ni/NiO earlier. Therefore there is probably a leakage in the range of this group of cells.

FIG. 6 shows various cell voltage curves or cell group voltage curves with respect to time in case of a complete cut-off of the gas supplies. Here the solid lines indicate the voltages of individual cells while the broken line shows a mean value of three cells. One of these cells is leaking. It can be seen that the analysis of cell voltage with respect to the time alone hardly enables the group to be recognised as conspicuous while this is absolutely possible with the differential method as explained in connection with FIG. 5.

In connection with the method according to the invention it is to be mentioned that the results show a strong dependence on the integration of the system in a test stand. It is, for example, to be observed whether at least one side of the anode space is closed. Furthermore, it has to be taken into consideration how long an open end of the anode space, i.e. the pipe of the combustion gas discharge, is. Further, great value is to be set on a tight interface between the fuel cells stack and the test stand.

The features of the invention disclosed in the above description, in the drawings as well as in the claims may be important for the realisation of the invention individually as well as in any combination.

1. A method for testing the leak-tightness of a fuel cell stack comprising the steps of:
operating the fuel cell stack using defined gas supply rates,
defining a modification of at least one gas supply rate,
detecting at least one cell or cell group voltage, and
analysing the variation in time of the at least one cell or cell group voltage.

2. The method of claim 1, characterised in that the variation in time of the voltage itself is taken into consideration in the analysis of the variation in time of the voltage.

3. The method of claim 1, characterised in that the first derivative of the voltage with respect to time is taken into consideration in the analysis of the variation in time of the voltage.

4. The method of claim 1, characterised in that a second derivative of the voltage with respect to time is taken into consideration in the analysis of the variation in time of the voltage.

5. The method of claim 1, characterised in that the analysis of the variation in time of the voltage comprises a comparison of the variation in time of the voltages of different cells or cell groups.

6. The method of claim 1, characterised in that the analysis of the variation in time of the voltage comprises a comparison of variation in time of voltages with variation of time of voltages to be expected in case of a sufficient leak-tightness.

7. The method of claim 1, characterised in that at least one cell or cell group voltage is detected prior to the defined change of the gas supply rate and in that the defined change of the at least one gas supply rate is induced after the at least one cell or cell group voltage is substantially constant.

8. The method of claim 1, characterised in that the defined change of the at least one gas supply rate is induced by a complete cut-off of at least one gas supply.

9. The method of claim 1, characterised in that the defined change of the at least one gas supply rate is induced by changing the pressure of the at least one gas supply while maintaining the gas supply.

10. The method of claim 1, characterised in that the supply rates of the gases supplied to the anode spaces as well as to the cathode spaces are changed in a defined manner.
